(19) United States
(12) Patent Application Publication
(10) Pub. No.: US 2025/0147732 A1
(43) Pub. Date: May 8, 2025

(54) PARALLEL POLYNOMIAL MODULAR MULTIPLICATION USING NTT AND INVERSE NTT

(71) Applicants: Regents of the University of Minnesota, Minneapolis, MN (US); Clemson University Research Foundation, Clemson, SC (US)

(72) Inventors: Keshab K. Parhi, Minneapolis, MN (US); Weihang Tan, Minneapolis, MN (US); Sin-Wei Chiu, Minneapolis, MN (US); Antian Wang, Shanghai (CN); Yingjie Lao, Clemson, SC (US)

(21) Appl. No.: 18/500,670

(22) Filed: Nov. 2, 2023

(51) Int. Cl. G06F 7/72; G06F 17/14

(52) U.S. Cl. CPC G06F 7/722; G06F 7/728; G06F 17/14

(57) ABSTRACT

A method comprises receiving a modulus for a number-theoretic transform of a polynomial and selecting a plurality of prime moduli whose product forms the modulus for the number-theoretic transform, wherein the plurality of prime moduli are selected by giving preference to prime moduli having fewer ones in a binary representation of the prime moduli. For each prime modulus in the plurality of prime moduli: dividing a coefficient of the polynomial into segments and performing modular reduction of the segments relative to the prime modulus. Performing the modular reduction of at least one segment comprises implementing a multiplication of a value by a modular reduction of a base value relative to the prime modulus using a shift-add-unit having a smaller area requirement than a modular multiplier. A modular reduction of the coefficient relative to the prime modulus is determined based on the modular reductions of the segments.

### BACKGROUND

High-speed long polynomial multiplication is important for applications in homomorphic encryption and lattice-based cryptosystems. For homomorphic encryption, such multiplications are performed on a number-theoretic transform of the polynomials.

The discussion above is merely provided for general background information and is not intended to be used as an aid in determining the scope of the claimed subject matter. The claimed subject matter is not limited to implementations that solve any or all disadvantages noted in the background.

### SUMMARY

A method comprises receiving a modulus for a number-theoretic transform of a polynomial and selecting a plurality of prime moduli whose product forms the modulus for the number-theoretic transform, wherein the plurality of prime moduli are selected by giving preference to prime moduli having fewer ones in a binary representation of the prime moduli. For each prime modulus in the plurality of prime moduli: dividing a coefficient of the polynomial into segments and performing modular reduction of the segments relative to the prime modulus. Performing the modular reduction of at least one segment comprises implementing a multiplication of a value by a modular reduction of a base value relative to the prime modulus using a shift-add-unit having a smaller area requirement than a modular multiplier. A modular reduction of the coefficient relative to the prime modulus is determined based on the modular reductions of the segments.

In accordance with a further embodiment, a specialized circuit for performing a number-theoretic transform is provided that includes a decomposition circuit for decomposing a coefficient of a polynomial into a plurality of values for a plurality of segments of the coefficient and that further includes a plurality of identical circuit blocks. Parallel sets of conductors connect the decomposition circuit to the plurality of identical circuit blocks, wherein multiple respective sets of conductors are connected to each identical circuit block. Each identical circuit block comprises at least one shift-add-unit.

In accordance with a still further embodiment, a circuit includes a partial number-theoretic transform circuit having a plurality of stages, each stage comprising a respective processing element and a respective delay-switch-delay circuit, wherein together, the respective delay-switch-delay circuits are controlled to implement a first folding set. A transition and operator circuit coupled to the partial number-theoretic transform circuit provides a final stage of the number-theoretic transform circuit, a pointwise operation on outputs of the number-theoretic transform circuit and a first stage of an inverse number-theoretic transform circuit. A partial inverse number-theoretic transform circuit receives values from the first stage of the inverse number-theoretic transform circuit and includes a plurality of stages, each stage comprising a respective processing element and a respective delay-switch-delay circuit, wherein together, the respective delay-switch-delay circuits of the inverse number-theoretic transform circuit are controlled to implement a second folding set different from the first folding set.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 provides a data flow graph for low-complexity NTT and iNTT for polynomial multiplication when n=8.

FIG. 2 provides a simple block diagram of a modular polynomial multiplier using two-parallel NTT and iNTT.

FIG. 3 provides a data flow graph of a 16-point forward NTT.

FIG. 4 provides a data flow graph of a 16-point iNTT.

FIG. 5 provides a block diagram of a circuit for performing NTT in accordance with one embodiment.

FIG. 6 provides a block diagram of a delay-switch-delay circuit in accordance with one embodiment.

FIG. 7 provides a block diagram of a circuit for performing iNTT in accordance with one embodiment.

FIG. 8 provides a block diagram of an NTT processing element.

FIG. 9 provides a block diagram of an iNTT processing element.

FIG. 10 provides a flow diagram of a method for performing NTT transforms, operations and iNTT transforms in accordance with one embodiment.

FIG. 11(a) is a block diagram of a prior art residual coefficient computation circuit.

FIG. 11(b) is a block diagram of a residual coefficient computation circuit of one embodiment.

FIG. 12 is a block diagram of a Shift Add Unit in accordance with one embodiment.

FIG. 13 is a flow chart of a residual coefficient computation unit when t=4.

FIG. 14 is a block diagram of a residual coefficient computation circuit with additional Barrett reduction units.

FIG. 15 is a block diagram of a residual coefficient computation circuit with duplicate blocks.

FIG. 16(a) is a block diagram of an inverse residual mapping circuit before optimization.

FIG. 16(b) is a block diagram of an inverse residual mapping circuit in accordance with one embodiment.

FIG. 17 is a chart comparing latency of NTT-based polynomial multiplication under the prior art and in accordance with one embodiment.

FIG. 18 is a flow diagram of a method of performing NTT-based polynomial multiplication in accordance with one embodiment.

FIG. 19 is a block diagram of a circuit for performing NTT-based polynomial multiplication in accordance with one embodiment.

FIG. 20 is a block diagram of NTT stages in the block diagram of FIG. 19.

FIG. 21 is a block diagram of transition stages and operators of the block diagram of FIG. 19.

FIG. 22 is a block diagram of iNTT stages in the block diagram of FIG. 19.

FIG. 23 is a flow diagram of a method of determining modular reductions of polynomial coefficients in accordance with one embodiment.

### DETAILED DESCRIPTION

Privacy-preserving protocols and the security of the information are essential for cloud computing. To this end, cloud platforms typically encrypt the data by certain conventional symmetric-key or asymmetric-key cryptosystems to protect user privacy. However, these methods cannot prevent information leakage during the computation on the cloud since the data must be decrypted before the computation. To further enhance privacy, homomorphic encryption (HE) has emerged as a promising tool that can guarantee the confidentiality of information in an untrusted cloud.

Homomorphic multiplication and homomorphic addition are two fundamental operations for the HE schemes. Most of the existing HE schemes are constructed from the ring-learning with errors (R-LWE) problem that adds some noise to the ciphertext to ensure post-quantum security. However, the quadratic noise growth of homomorphic multiplication requires the ciphertext modulus to be very large, which results in inefficient arithmetic operations. One possible solution to address this issue is to decompose the modulus and execute it in parallel. This approach has been used in residue number system (RNS) representation. However, RNS relies on the Chinese remainder theorem (CRT), which requires additional pre-processing and post-processing operations. The hardware building blocks for these steps need to be optimized; otherwise, the complexity of the RNS system will negate the advantages of parallelism of the RNS. Meanwhile, modular polynomial multiplication is one of the essential arithmetic operations for the R-LWE problem-based cryptosystems and, indeed, HE schemes. The complexity of the number-theoretic transform (NTT)-based modular polynomial multiplication can be reduced dramatically compared to the schoolbook-based modular polynomial multiplication.

Different modular long polynomial multiplier architectures can be adopted for different applications. For example, a low-area time-multiplexed architecture is well-suited for an edge device. However, the cloud requires very high-speed architectures where multiple coefficients of the polynomial need to be processed in a clock cycle. This inherently requires a parallel architecture where the level of parallelism corresponds to the number of coefficients processed in a clock cycle. Computing the inverse NTT (INTT) of the product of NTT of the two polynomials can lead to long latency and extra buffer requirement if its scheduling aspects are not considered as the product needs to be shuffled before the iNTT is computed.

Although parallel NTT-based architectures can achieve low latency and high speed, these require a large silicon area for the arithmetic operations as the word-lengths of the coefficients can be large. To reduce the area, residue arithmetic is used to convert the coefficient into several smaller coefficients that can be implemented using shorter word lengths.

Embodiments described below provide parallel residue arithmetic and NTT-based modular long polynomial multiplication referred to as PaReNTT. The use of different scheduling (folding) of the NTT and iNTT operations eliminates the need for additional buffers. Thus, the latency of the complete operation is reduced. The use of parallel NTT architecture reduces the number of clock cycles needed to process the long polynomial modular multiplication. The parallel NTT and iNTT architectures are completely feed-forward and achieve full hardware utilization. These can be pipelined at any arbitrary level.

The contributions of the embodiments are three-fold and are summarized below.
The cascaded NTT-iNTT architecture does not require intermediate shuffling operations. Different folding sets for the NTT and iNTT are used such that the product of the two NTTs can be processed immediately in the iNTT. This leads to a significant reduction in latency and completely eliminates the need for any intermediate buffer requirement.
A special format of primes for the CRT is used to reduce the cost of the implementation. Specifically, all the primes are not only NTT-compatible but also CRT-friendly and have low Hamming weights (i.e., these contain only a few signed power-of-two terms, in other words only include a few ones). Traditional selection of moduli to satisfy these constraints can limit the number of moduli available. A novel approach is proposed to expand the set of moduli that satisfy these constraints. This enables HE architectures for long word length coefficients.

Novel optimized architectures for pre-processing and post-processing for residue arithmetic are provided in the embodiments below. These architectures reduce area and power consumption. Finally, the low-cost pre-processing and post-processing blocks for the residue arithmetic are integrated into the parallel NTT-based modular polynomial multiplier to achieve high speed, low latency, and low area designs.

### Notation

For a polynomial ring R_{n,q}=Z_{q}[x]/(xⁿ+1), its coefficients have to be modulo q (i.e., these lie in the range [0, q−1]) and the degree of the polynomial is less than n (n is a power-of-two integer). To ensure all the intermediate results belong to the polynomial ring, a modular reduction operation is needed, which is expressed as “mod (xⁿ+1, q)” or [⋅]_{q}. The polynomial of the ring R_{n,q} is denoted as a(x)=Σⱼ₌₀ⁿ⁻¹aⱼx^{j}, where the j-th coefficient of the polynomial a(x) is represented as aⱼ.

The addition and multiplication of two polynomials modulo (xⁿ+1, q) (i.e., modular polynomial addition and multiplication) are written as a(x)+b(x) and a(x)·b(x), respectively. We also use ⊙ to denote the point-wise multiplication over (xⁿ+1, q) between two polynomials. Parameters m=log₂ n and s∈[0, m−1] represent the total number of stages and the current stage in the NTT (iNTT), respectively.

### Homomorphic Encryption

HE allows the computations (e.g., multiplication, addition) directly on the ciphertext, without decryption, so that the users can upload their data to any (even untrusted) cloud servers while preserving privacy. The HE schemes can be broadly classified as fully HE (FHE) and somewhat HE (SHE). The FHE schemes allow an arbitrary number of homomorphic evaluations while suffering from high computational complexity. SHE is an alternative solution with better efficiency than the FHE, which only allows performing a limited number of operations without decryption.

High-level steps for HE schemes can be summarized in four stages: key generation, encryption, evaluation, and decryption. In particular, the key generation step is used to output three keys: the secret key, public key, and relinearization key, based on the security parameter λ. Then, using the public key, the encryption algorithm encrypts a message into a ciphertext ct. During the evaluation step, a secure evaluation function performs a computation homomorphically for all input ciphertexts and outputs a new ciphertext ct′ using the relinearization key. Finally, the result can be obtained using the secret key and ct′ in the decryption step.

Key generation, encryption, and decryption steps are generally executed by the client. Meanwhile, the evaluation step is distributed to the cloud server for homomorphic computation. Different homomorphic evaluation functions have different computational costs. The homomorphic addition is relatively simple since it is implemented by modular polynomial additions. However, homomorphic multiplication requires expensive modular polynomial multiplication. Thus, the hardware or software accelerations for the modular polynomial multiplier, especially under the HE parameters with large degrees of polynomial and long word-length coefficients, are demanding.

### Residue Number System

To implement homomorphic encryption in various applications, the depth of homomorphic multiplication increases proportionally with respect to the word-length of the coefficient. As an example, performing a depth of four homomorphic multiplications with an 80-bit security level requires a 180-bit ciphertext modulus and length-4096 polynomial. However, the computation involving the long word-length coefficients is not trivial, which is also inefficient without high-level transformations. Since the moduli in most widely-used SHE schemes, e.g., BGV, BFV, and CKKS, are not restricted to be primes, it is possible to choose each modulus to be a product of several distinct primes by using CRT, where each prime is an NTT-compatible prime with a small word-length.

The CRT algorithm decomposes q to q₁, q₂, . . . , qₜ (i.e., q=Πᵢ₌₁^{t}qᵢ, and qᵢ's are mutually co-prime), and the ring isomorphism R_{q}=R_{q}_{₁}×R_{q}_{₂}, . . . , ×R_{q}_{ₜ}. After this decomposition, ring operation in each R_{q}_{ᵢ} is performed separately, which thus can be executed in parallel. From the implementation perspective, the larger the parameter t, the smaller each qᵢ and the simpler arithmetic operation over R_{q}_{ᵢ}.

### NTT-Based Polynomial Multiplication

In addition to the long word-length of the coefficient, the long polynomial degree n can be in the range of thousands for the HE schemes to maintain the high security level, which becomes the bottleneck for the implementations in both software and hardware. Therefore, an efficient NTT-based polynomial multiplication method with the time complexity of O(nlogn) is used.

To compute p(x)=a(x)·b(x) mod (xⁿ+1, q), polynomials a(x) and b(x) are first mapped to their NTT-domain polynomials A(x) and B(x). For instance, the NTT computation for polynomial a(x) is expressed as: A(x)=Σⱼ₌₀ⁿ⁻¹aⱼωₙ^{kj} mod q, where k∈[0, n−1]. ω is the primitive n-th root of unity modulo q (i.e., twiddle factor), which satisfies ωⁿ≡1 mod q. Subsequently, an efficient point-wise multiplication between A(x) and B(x), yields P(x)=A(x)⊙B(x). The final result is obtained via iNTT computation: p(x)=Σⱼ₌₀ⁿ⁻¹Pⱼωₙ^{-kj} mod q, where k∈[0, n−1].

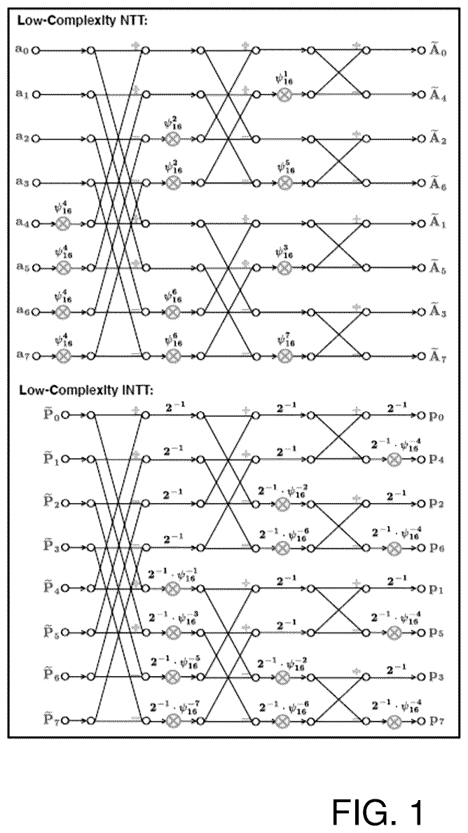

This method significantly reduces the time complexity compared to the O(n²) complexity method of the schoolbook polynomial multiplication along with the modular polynomial reduction. However, this original method involves zero padding of length n, which doubles the length of the polynomial in the NTT/iNTT computation. It has been shown that by using negative wrapped convolution (NWC), zero padding can be completely eliminated. However, this requires that the inputs and outputs need to be weighted. These additional weight operations can be eliminated by reformulation of the algorithm. This is referred to as low-complexity negative wrapped convolution. Flow graphs for low-complexity NWC-based NTT and iNTT are shown in FIG. 1 for n=8. In particular, ψ₂ₙ is the primitive 2n-th root of unity modulo q, where q is a NTT-compatible prime such that (q−1) is divisible by 2n. This low-complexity algorithm reduces the number of modular integer multiplications. Meanwhile, the modular multiplication by 2⁻¹ can be efficiently implemented using low-cost modular adders and a multiplexer (MUX) in hardware.

### Parallel NTT-Based Polynomial Multiplier without Shuffling Operations

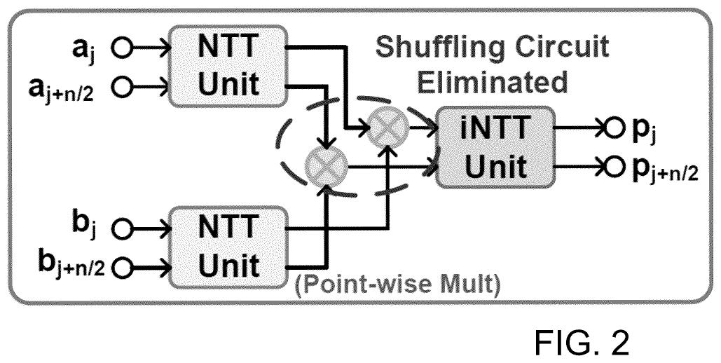

This section describes a real-time, feedforward, high-throughput, and parallel NTT-based polynomial multiplication architecture design that does not require intermediate shuffling, as shown in FIG. 2. For a conventional implementation, an additional shuffling circuit is typically used for reordering output data before computing iNTT. However, such a shuffling circuit requires a large number of clock cycles and registers. In the present architecture, the two parallel products are fed into a two-parallel iNTT architecture such that no intermediate buffer is needed. Thus, the outputs of the product are executed immediately by the iNTT. This is possible becuase different folding sets are used in the NTT and iNTT. Moreover, the architecture is generalized for any value of n, parameterized, and can achieve an arbitrary level of pipelining to achieve high-speed operation.

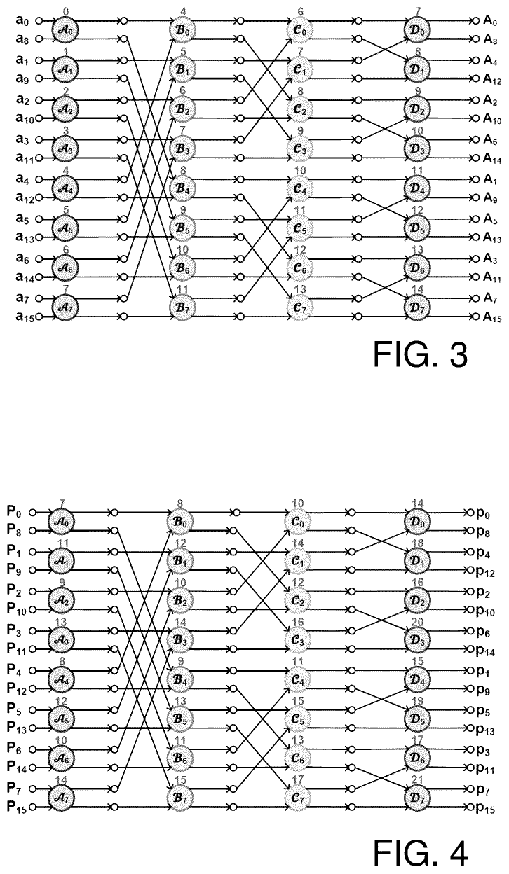

In particular, the NTT/iNTT units in FIG. 2 are based on a two-parallel architecture using appropriate folding sets and the folding transformation. FIG. 3 and FIG. 4 show the data-flow graphs for 16-point forward NTT of a(x) and iNTT for P(x), respectively, where each circle represents one butterfly operation.

After applying the folding transformation, the operations in the same color, i.e., in the same stage, are processed by the same PE and then executed in a time-multiplexed manner. The order in which the butterfly operations are executed in the same PE is referred to as the folding order. Also, the corresponding clock cycle for each butterfly operation is highlighted in blue in FIG. 3 and FIG. 4. In this 16-point example, the folding set (i.e., the ordered set of operations executed in each PE) of the forward NTT is expressed as:

$$A = \{ {A}_{0} , {A}_{1} , {A}_{2} , {A}_{3} , {A}_{4} , {A}_{5} , {A}_{6} , {A}_{7} \} \qquad ( 1 )$$

$$B = \{ {B}_{4} , {B}_{5} , {B}_{6} , {B}_{7} , {B}_{0} , {B}_{1} , {B}_{2} , {B}_{3} \}$$

$$C = \{ {C}_{2} , {C}_{3} , {C}_{4} , {C}_{5} , {C}_{6} , {C}_{7} , {C}_{0} , {C}_{1} \}$$

$$D = \{ {D}_{1} , {D}_{2} , {D}_{3} , {D}_{4} , {D}_{5} , {D}_{6} , {D}_{7} , {D}_{0} \} .$$

In order to avoid intermediate buffer or data format conversion from NTT to iNTT, the output samples from the last PE in the NTT unit should be fed into the first PE in the iNTT unit at the same clock cycle (ignoring the clock cycles for determining the product). This is achieved using the following folding set for the iNTT:

$$= \{ {A}_{4} , {A}_{2} , {A}_{6} , {A}_{1} , {A}_{5} , {A}_{3} , {A}_{7} , {A}_{0} \} \qquad ( 2 )$$

$$= \{ {B}_{0} , {B}_{4} , {B}_{2} , {B}_{6} , {B}_{1} , {B}_{5} , {B}_{3} , {B}_{7} \}$$

$$= \{ {C}_{3} , {C}_{7} , {C}_{0} , {C}_{4} , {C}_{2} , {C}_{6} , {C}_{1} , {C}_{5} \}$$

$$= \{ {D}_{2} , {D}_{6} , {D}_{1} , {D}_{5} , {D}_{3} , {D}_{7} , {D}_{0} , {D}_{4} \} .$$

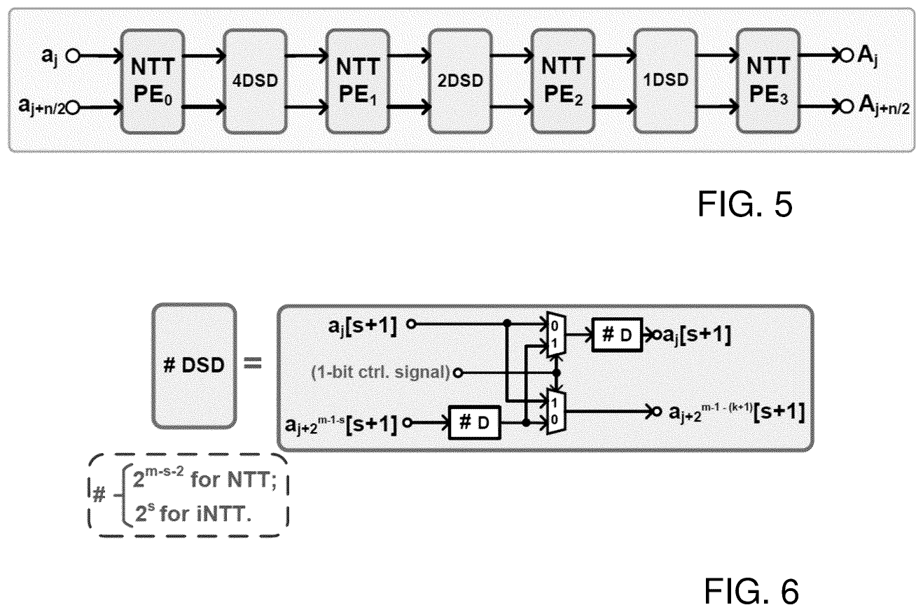

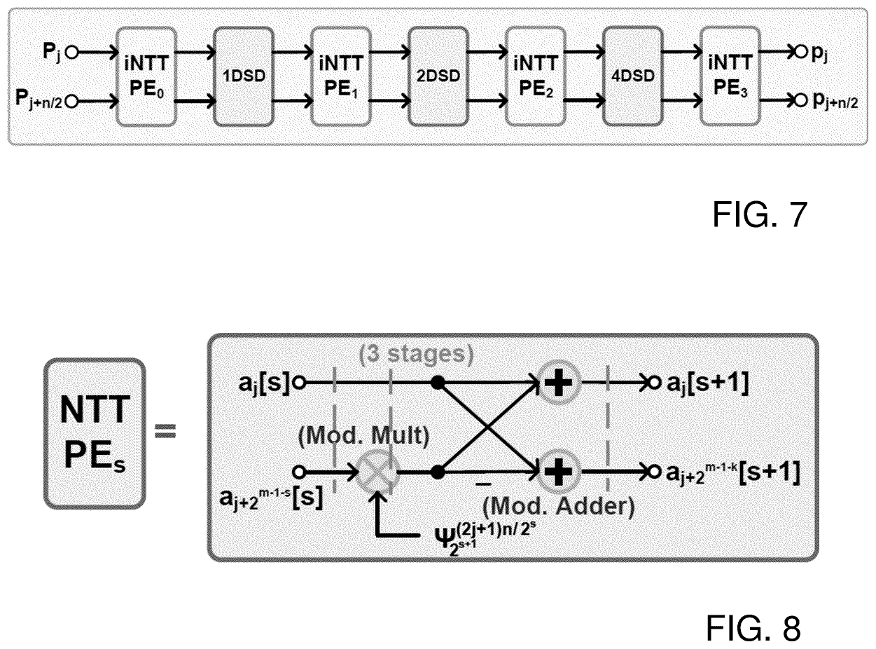

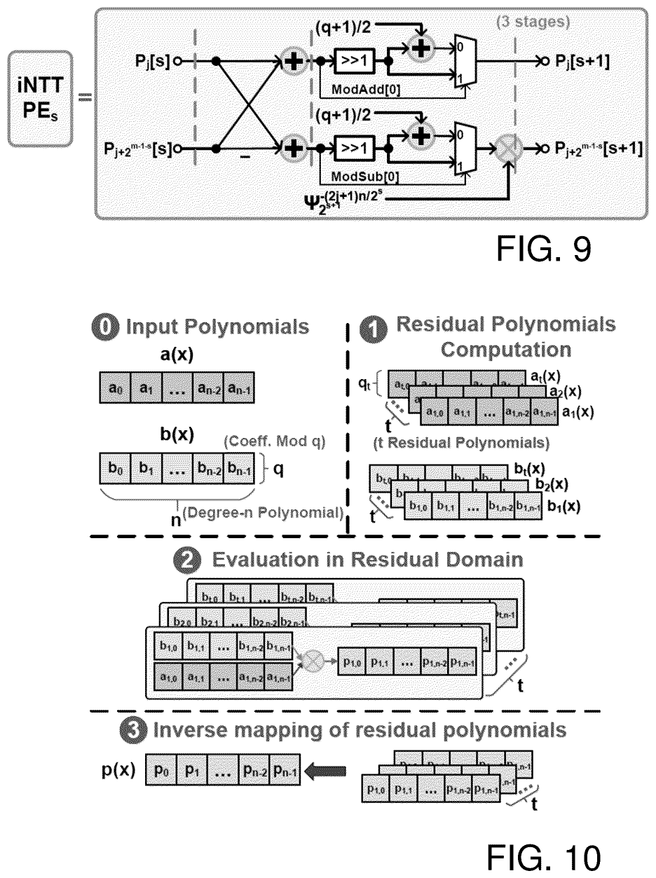

The NTT architecture in FIG. 5 is derived using the folding sets shown in Equation (1). Specifically, this architecture has four PEs and three delay-switch-delays (DSDs), where the structures for PE and DSD are illustrated in FIG. 8 and FIG. 6, respectively. Besides, the DSD block utilizes two MUXs and two register sets, such that it can store the specific data in the data-path and then either switch or pass the data to the PE. Note that the number of registers inside each register set is varied in different stages. In the s-th stage, each register set has 2^{m-s-2} registers in the DSD block for the NTT architecture. Furthermore, the architecture for iNTT is shown in FIG. 7, and its components are described in FIG. 9 and FIG. 6. FIG. 9 shows a hardware-friendly PE design for iNTT that only involves one right shift operation, one modular addition with constant

$$\frac{q + 1}{2} ,$$

and one MUX for one modular division by two. One of the main differences between NTT and iNTT architectures is the number of registers located inside each DSD block since they are determined by the folding set as in Equation (2). Specifically, 2^{s} registers are required for each register set in the s-th stage for the iNTT architecture. Even though the operations of NTT and iNTT are very similar, we consider two separate architectures instead of considering a unified and reconfigurable architecture. The rationale is as follows. Since modular multiplications are heavily used in homomorphic multiplication, using two different architectures for NTT and iNTT allows a continuous flow of the input polynomials and thus can highly accelerate the HE multiplication.

The 16-point architectures in FIG. 5 and FIG. 7 can also be easily generalized to any power-of-two length n by having m PEs and (m−1) DSDs blocks. Furthermore, the general case NTT and iNTT folding sets are defined as follows. We denote the PE in s-th stage as PEₛ, and the NTT folding set for the butterfly operations performed inside this PE are illustrated in Table I. The entries in Table I describe the node index of the node of that stage in the data-flow graph. The folding order describes the clock partition at which the node is executed. For example, a folding order s implies that the node is executed at clock cycle (n/2)l+s where l is an integer. The cardinality of the folding set is n/2 as there are n/2 operations (nodes) in an NTT stage. Thus the scheduling period is n/2.

The folding set for iNTT can also be generalized as in Table II, where the symbol “ [symbol] ⋅ [symbol] ” means the bit-reverse representation for the folding set with respect to a (m−1) bit integer (e.g., [symbol] 1 [symbol] = [symbol] 001_{b} [symbol] =100_{b}=4 when m=4). Specifically, if a node i in the NTT has folding order i, the folding order of the corresponding node in iNTT is [symbol] i [symbol] −1 modulo (n/2). While the bit-reversed scheduling has been known to eliminate latency and buffer requirements at the dataflow graph level, the observation that the same property holds in a parallel NTT-iNTT cascade is non-intuitive.

Note that if the iNTT was designed using the same folding set in Equation (1), the product would need to be input to a DSD of size 4 (n/4 in general). This would introduce an additional latency of 4 (n/4 in general) clock cycles. The use of different folding sets for NTT and iNTT eliminates any additional DSD circuit and its associated latency.

TABLE I
GENERALIZED FOLDING ORDER FOR NTT

| Folding Order | 0 | 1 | | l | | $\frac{n}{2} - 1$ |
|---|---|---|---|---|---|---|
| PE₀ | 0 | 1 | ... | l | | $\frac{n}{2} - 1$ |
| PE₁ | 2^{m-2} | 2^{m-2} + 1 | ... | ${2}^{m - 2} + 1 mod \frac{n}{2}$ | ... | 2^{m-2} − 1 |

...

| | | | | | | |
|---|---|---|---|---|---|---|
| PEₛ | 2^{m-s-1} | 2^{m-s-1} + 1 | ... | ${2}^{m - s - 1} + 1 mod \frac{n}{2}$ | ... | ${2}^{m - s - 1} - 1 mod \frac{n}{2}$ |

...

| | | | | | | |
|---|---|---|---|---|---|---|
| PEₘ₋₁ | 1 | 2 | ... | l + 1 | ... | 0 |

TABLE II
GENERALIZED FOLDING ORDER FOR iNTT

| Folding Order | 0 | 1 | | l | | $\frac{n}{2} - 1$ |
|---|---|---|---|---|---|---|
| PE₀ | [symbol] 1 [symbol] | [symbol] 2 [symbol] | ... | [symbol] l + 1 [symbol] | ... | [symbol] 0 [symbol] |
| PE₁ | [symbol] 0 [symbol] | [symbol] 1 [symbol] | ... | [symbol] 1 [symbol] | ... | [symbol] 2^{m} −1 − 1 [symbol] |

...

| | | | | | | |
|---|---|---|---|---|---|---|
| PEₛ | $〈 2 - {2}^{s} mod \frac{n}{2} 〉$ | $〈 2 - {2}^{s} + 1 mod \frac{n}{2} 〉$ | ... | $〈 2 - {2}^{s} + l mod \frac{n}{2} 〉$ | ... | $〈 2 - {2}^{s} - 1 mod \frac{n}{2} 〉$ |

...

| | | | | | | |
|---|---|---|---|---|---|---|
| PEm-1 | [symbol] 2 [symbol] | [symbol] 3 [symbol] | ... | $〈 l + 2 mod \frac{n}{2} 〉$ | ... | [symbol] 1 [symbol] |

### Moduli Selection and PaReNTT Architecture

### Overview of Proposed PaReNTT Architecture

FIG. 10 shows the overview of the proposed PaReNTT architecture, which can be divided into three constituent steps. The first step, referred to as residual polynomials computations (pre-processing operation), splits the two input polynomials into several polynomials whose coefficients are small. Rather than employing a single modular polynomial multiplier, several modular polynomial multiplications are executed in parallel in the residual domain. Subsequently, the post-processing operation performs the inverse mapping for the product polynomials to one polynomial using the CRT. The result is the same as directly performing the modular polynomial multiplication for two input polynomials.

### Special NTT-Compatible and CRT-Friendly Primes Selection

As opposed to randomly selecting the co-primes, the present embodiment utilize special co-primes to reduce the computational cost and the silicon area. The main idea of this optimization is to trade the flexibility of the co-primes selection for the timing/area performance of the architectures.

In the proposed architecture, each qᵢ not only is an NTT-compatible prime but also has a short word-length, which is defined as

$${q}_{i} = {2}^{v} - {β}_{i} , {β}_{i} = {2}^{{v}_{1 i}} \pm {2}^{{v}_{2 i}} \pm … \pm {2}^{{v}_{{n}_{q} i}} - 1 , \qquad ( 3 )$$

where v is the word-length of qᵢ, v₁ᵢ>v₂ᵢ . . . >vₙ_{_{q}}ᵢ. The number of signed power-of-two terms in qᵢ is (n_{q}+2).

The special NTT-compatible and CRT-friendly primes can be found through an exhaustive search for the t coprime factors and then combined to form the vt-bit ciphertext modulus, q. The two constraints that need to be satisfied are:

(1) (qᵢ−1) is a multiple of 2n and (2)

$$⌈ \frac{μ - 1}{{n}_{β}} ⌉ > {v}_{1 i} > {v}_{2 i} .$$

The second constraint is derived below; see Equation (6). Here μ is the word-length of the input to the Barrett reduction unit (see description C below). In a typical Barrett reduction implementation, μ=2v. In the proposed approach, for given v and t, μ and n_{q} are increased to expand the number of feasible moduli.

A CRT-friendly modulus leads to an optimized hardware architecture with respect to the overall timing and area performance for the pre-processing and post-processing steps. The embodiment's exhaustive search approach generates qᵢ that are similar to the Solinas prime, and contain a few signed power-of-two terms.

The integer multipliers have a larger area consumption and longer delay than the integer adders for the hardware implementation. Besides, the area and delay are proportional to the word-length. Therefore, to optimize the modular multiplier, pre-processing stage, and postprocessing stage architectures,the number of integer multipliers, especially the long integer multipliers, is reduced. In particular, all the integer multipliers are eliminated when multiplying by qᵢ, which significantly reduces the computation cost.

### Residual Polynomials Computation Unit

The pre-processing stage maps the input polynomials to their residual polynomials by applying the CRT algorithm, as shown in Step 1 of FIG. 10. For the polynomial a(x), its residual polynomials are

$${a}_{i} ( x ) = {[ a ( x ) ]}_{{q}_{i}} = {\sum }_{j = 0}^{n - 1} ( {a}_{i , j} mod {q}_{i} ) {x}^{j} , i ∈ [ 1 , t ] . \qquad ( 4 )$$

A key operation within the pre-processing stage is the execution of modular reduction. One approach to avoiding division operation in computing modular operation is the use of Barrett reduction. This is described by:

$$a mod q = a - ( \frac{a m}{{2}^{μ}} ) \cdot q = a - ( ( a ϵ ) ≫ μ ) \cdot q$$

where

$$ϵ = ⌊ \frac{{2}^{μ}}{q} ⌋$$

can be pre-computed, and μ is the wordlength of a.

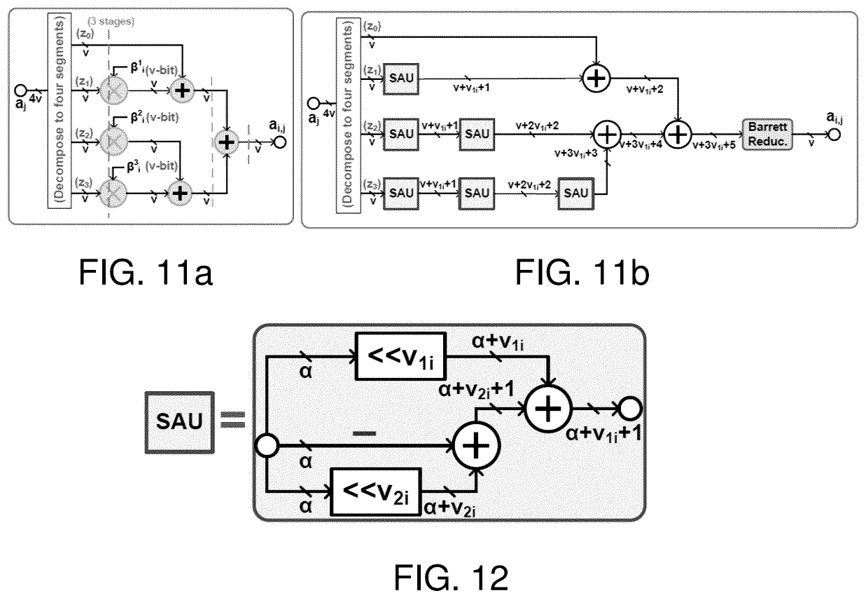

A divide-and-conquer paradigm for residual polynomials computation enhances the parallelism and reduces the complexity. An example of this method is shown in FIG. 11(a), demonstrating a fully parallel implementation for t=4. Despite its advantages, this method requires modular multiplication within each segment, presenting opportunities for further optimization. In particular, the present embodiments exploit the low Hamming weight property of the moduli and replace the modular multipliers by Shift Add Units (SAUs).

Algorithm 1 presents our optimization to implement Equation (4). The architectures for prior work and the present embodiments are shown in FIG. 11(a) and FIG. 11(b), respectively. Line 1 in Algorithm 1 begins by splitting a large integer aⱼ into several segments where each segment has v bits (v is the word-length of qᵢ). For simplicity, we define the base B=2^{v}. Thus, each segment within a_{i,j} can be expressed as zₖ·B^{k}, k∈[0, t−1]. The next step involves the modular reduction for each segment, which is the main focus of our hardware optimization.

Algorithm 1 Efficient residual coefficient computation

| Input: aⱼ ∈ [0,q − 1] and qᵢ | |
|---|---|
| Output: a_{i,j} = aⱼ mod qᵢ, a_{i,j} ∈ R_{qi} | |
| 1: | aⱼ = z₀ + z₁ · B + z₂ · B²+,...,+zₜ₋₁ · B^{t-1} //B = 2^{v} |
| 2: | for k = 1 to t − 1 do |
| 3: | rₖ = zₖ × βᵢ^{k} // βᵢ = B mod qᵢ |
| 4: | a_{i,j} = z₀ + r₁ + ... + rₜ₋₁ mod qᵢ |

Line 3 in Algorithm 1 does not requires vxv-bit integer multiplication with βᵢ^{k} to obtain each rₖ. Instead, the proposed method utilizes the shift and add operations to eliminate the expensive modular multiplications.

Besides, different from the baseline design in FIG. 11(a) where the modular reductions are required to reduce each rₖ modulo qᵢ, the present embodiments reduce (t−1) reduction units to only one in the ideal case, as required in Line 4 of Algorithm 1. The rationale behind this method is as follows. The product rₖ in the prior work is a 2v-bit integer, as βᵢ^{k} and zₖ are both v-bits each.

Since qᵢ only contains a few signed power-of-two terms, a long integer multiplication in Line 3 of Algorithm 1 is replaced by an SAU. For instance, for a special prime qᵢ=2^{v}−2^{v}^{₁ᵢ}−2^{v}^{₂ᵢ}+1, βᵢ in Line 3 of Algorithm 1 can be expressed as

$${β}_{i} = {[ {2}^{v} ]}_{{q}_{i}} {2}^{{v}_{1 i}} + {2}^{{v}_{2 i}} - 1 \qquad ( 5 )$$

The multiplication by βᵢ using SAU is shown in FIG. 12. Here, the word-length of z₁×βᵢ is (v+v₁ᵢ+1). After n_{β} SAUs, the word-length is increased to (v+n_{β}(v₁ᵢ+1)). The word-length of a_{i,j} at Line 4 of Algorithm 1, μ, is greater than or equal to (v+n_{β}(v₁ᵢ+1)+1), where μ is the word-length of the input to the Barrett reduction unit. This leads to the constraint:

$$⌈ \frac{μ - 1}{{n}_{β}} ⌉ > {v}_{1 i} > {v}_{2 i} . \qquad ( 6 )$$

The parameter n_{β}=t−1 in the general case.

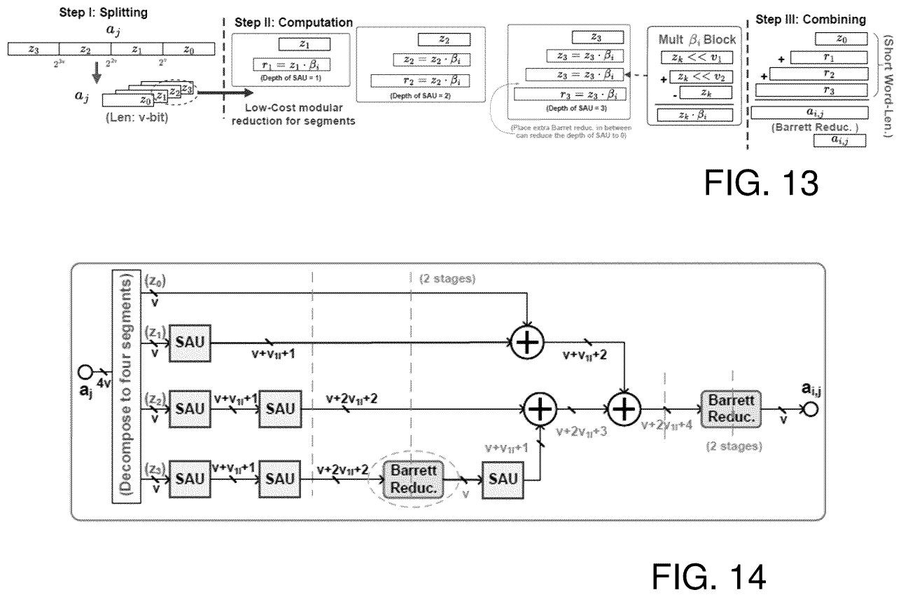

A block diagram to illustrate Algorithm 1 is shown in FIG. 13, for t=4. It can be seen that the modular multiplication in zₖ×βᵢ^{k} in FIG. 11(a) can be replaced by the shift and add operations, resulting in reduced hardware costs. Since a multiplier is typically quadratically more expensive than an adder with respect to word-length, using such a shift and add operation is more area efficient than using a multiplier to obtain its result rₖ.

### Increasing the Number of Primes as Required

An increase in the number of co-prime factors t can eventually deepen the depth of the SAU, resulting in a long word-length in the intermediate result, thus yielding inefficient computation. To overcome this bottleneck, two alternative solutions are employed.

Approach 1. The first solution involves the simple strategic placement of an extra Barrett reduction unit within the data-path, aiming to decrease the maximum depth of SAU. Inserting additional Barrett reductions between the SAUs can reduce the depth of SAU to zero and consequently decrease the word-length of the intermediate result to v-bit. For instance, the application of an additional Barrett reduction unit for r₃ can minimize the depth of SAU to 1, as shown in FIG. 14 and FIG. 13, ensuring all input word lengths for Barrett reduction units are short. Consequently, as the operating intermediate results rₖ are represented using short word lengths, combining all the rₖ and z₀ to calculate a_{i,j} requires only adders and a Barrett reduction unit. Despite this overhead, it maintains a smaller hardware resource requirement than the prior design, as shown in FIG. 11(a), owing to a reduced number of Barrett reduction units and the elimination of integer multiplication. This method is appropriate when the number of moduli is small (for example, less than 5).

Approach 2. When the number of moduli, t, is large, the above approach is not efficient, as the number of SAUs grows in a square manner with t. For this case, the embodiments use an approach described in Algorithm 2 below. First, t is decomposed as t=d·t′ where t′ segments are combined using SAUs similar to Approach 1 and form a block. Then d such blocks are used, where each block processes t′ segments. The maximum depth of SAUs in each block is (t′−1).

Note that the co-prime factors used in this approach require an adjustment n_{β}=t′−1 in Equation (5) in order to satisfy the condition

$$⌈ \frac{μ - 1}{{n}_{β}} ⌉ > {v}_{1 i} > {v}_{2 i} .$$

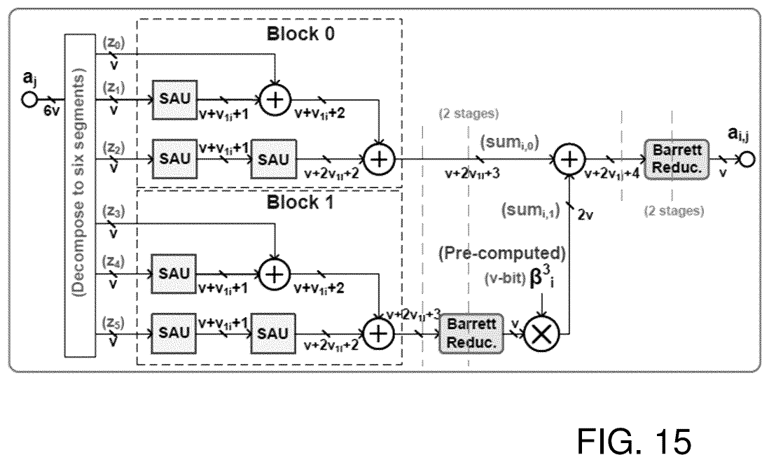

FIG. 15 illustrates an example for six co-prime factors (t=6). This circuit primarily comprises two blocks (d=2) of SAU units, where each block has three inputs (t′=3), augmented with additional Barrett reduction units and one multiplier. In this example, each segment zₖ undergoes modular reduction by multiplying βᵢ^{k}, where k∈[0, 5]. The first block computes the multiplication with βᵢ⁰ to βᵢ² by using low-cost SAUs:

$${sum}_{i , 0} = {z}_{0} \cdot {β}_{i}^{0} + {z}_{1} \cdot {β}_{i}^{1} + {z}_{2} \cdot {β}_{i}^{2} \qquad ( 7 )$$

Since βᵢ⁰=1, no modular operations are needed for z₀.

Segments z₃ to z₅ serve to execute the modular reduction, which are subsequently optimized through the application of the distributivity property of multiplication:

$${sum}_{i , 1} = {[ {z}_{3} \cdot {β}_{i}^{3} + {z}_{4} \cdot {β}_{i}^{4} + {z}_{5} \cdot {β}_{i}^{5} ]}_{{q}_{i}} , {sum}_{i , 1} = {{[ {z}_{3} \cdot {β}_{i}^{0} + {z}_{4} \cdot {β}_{i}^{1} + {z}_{5} \cdot {β}_{i}^{2} ]}_{{q}_{i}} [ {β}_{i}^{3} ]}_{{q}_{i}} \qquad ( 8 )$$

where [z₃·βᵢ⁰+z₄·βᵢ¹+z₅·βᵢ²]_{q}_{ᵢ} can be implemented through identical components in the first block with the SAU units, followed by a Barrett reduction unit, and the multiplication [βᵢ³]_{q}_{ᵢ} (a v-bit pre-computed constant) instantiated through a (v×v)-bit multiplier. This novel optimization in Equation (8) ensures the intermediate result of sum_{i,1} is fixed to 2v-bit. Ultimately, sum_{i,0} and sum_{i,1} are accumulated and reduced to a v-bit result by a Barrett reduction unit.

Algorithm 2 Efficient residual coefficient
computation by Factorization

| Input: aⱼ ∈ [0,q − 1], qᵢ, and t = t′ · d | |
|---|---|
| Output: a_{i,j} = aⱼ mod qᵢ, a_{i,j} ∈ R_{qi} | |
| 1: | aⱼ = z₀ + z₁ · B + z₂ · B²+,...,+zₜ₋₁ · B^{t-1} //B = 2^{v} |
| 2: | for ρ = 0 to d − 1 do |
| 3: | for k = 1 to t′ − 1 do |
| 4: | rₖ = zₖ × βᵢ^{k} // βᵢ = B mod qᵢ |
| 5: | if ρ == 0 then |
| 6: | sum_{i,0} = z₀ + r₁ + ... + r_{t′-1} |
| 7: | else |
| 8: | sum_{i,ρ} = [z₀ + r1 + ... + r_{t′-1}]_{qi} · [βᵢ^{ρt′}]_{qi} |
| 9: | a_{i,j} = sum_{i,0} + sum_{i,1} + ... + sum_{i,d-1} mod qᵢ |

In terms of computational complexity analysis, this method demonstrates a reduction in hardware resource consumption. Compared to the design in FIG. 11(a), this approach reduces the number of integer multipliers and modular reduction units from t and t to (d−1) and d, respectively.

However, additional

$$\frac{t ( {t}^{′} - 1 )}{2} SAUs$$

are used. For example, the proposed method reduces six integer multipliers and six modular reduction units to one integer multiplier and two modular reduction units when t=2·3. It is important to know that employing this method does not mandate the constraint parameter of t=6 for co-prime (qᵢ) generation during the exhaustive search procedure. On the contrary, it leverages the constraint parameter of t′=3 to achieve six satisfied coprime factors since the maximum depth of SAU unit is two (i.e., n_{β}=2 instead of n_{β}=5), which markedly broadens the flexibility of the search space for co-prime factors.

### Evaluation in Residual Domain

After using CRT representation, the function f(aᵢ(x),bᵢ(x)) over R_{n,q}_{ᵢ} can be computed independently, as presented in Step 2 in FIG. 10. As a result, the overall t operations can be executed in parallel. In our case, the function computes the residual products pᵢ(x) for i∈[1, t], by utilizing NTT-based polynomial multiplication over R_{n,q}_{ᵢ}. The architecture to compute pᵢ(x)=aᵢ(x)·bᵢ(x) mod (xⁿ+1, qᵢ) is based on our novel NTT-based polynomial multiplier in FIG. 2. Thus, our proposed architecture achieves high throughput and low latency by increasing the parallelism from the CRT representation.

### Inverse Mapping of Residual Coefficients of Polynomials

During Step 3 in FIG. 10, the results obtained by the evaluation in the residual domain need to be converted back to over the ring R_{n,q}, which is the same as f(a(x),b(x)) over R_{n,q} (i.e., result computed without using CRT representation).

This post-processing stage is based on the inverse CRT algorithm:

$$p ( x ) = {\sum }_{i = 1}^{t} {p}_{i} ( x ) \cdot {e}_{i} mod q , = {\sum }_{i = 1}^{t} {\sum }_{j = 0}^{n - 1} {p}_{i , j} \cdot {e}_{i} {x}^{j} mod q \qquad ( 9 )$$

where each eᵢ=qᵢ*·\tilde{q}ᵢ is a constant,

$${q}_{i}^{*} = ( \frac{q}{{q}_{i}} ) ∈ ℤ , and {\tilde{q}}_{i} = {[ {( \frac{q}{{q}_{i}} )}^{- 1} ]}_{{q}_{i}} ∈ {ℤ}_{{q}_{i}} .$$

However, direct multiplication by the constant eᵢ involves a long integer multiplication and expensive modular reduction over q, which will result in an inefficient implementation and a long critical path. Meanwhile, the properties of the special coprimes can lower the cost of modular operations over qᵢ in the post-processing stage. Therefore, the embodiments express Equation (9) as:

$$p ( x ) = {\sum }_{i = 1}^{t} {[ {p}_{i} ( x ) \cdot {\tilde{q}}_{i} ]}_{{q}_{i}} \cdot {q}_{i}^{*} mod q = {{\sum }_{i = 1}}^{t} {\sum }_{j = 0}^{n - 1} {[ {p}_{i , j} \cdot {\tilde{q}}_{i} ]}_{{q}_{i}} \cdot {q}_{i}^{*} \cdot {x}^{j} mod q . \qquad ( 10 )$$

The core concept of this methodology is the partitioning of a long word-length v×vt-bit multiplier into a v×v-bit multiplier coupled with a v×(t−1) v-bit multiplier. Thus, the modular reduction with respect to q is replaced by four separate modular reductions in terms of different qᵢ. The resource savings achieved through this optimization can be explained as follows:

The computation in 0≤[p_{i,j}·\tilde{q}ᵢ]_{q}_{ᵢ}<qᵢ can be performed efficiently since the modular reduction over qᵢ has a lower cost than the modular reduction q. As qᵢ* is a (t−1) vbit pre-computed constant, no division is required in the postprocessing stage. Besides, the range of the coefficients from [p_{i,j}·\tilde{q}ᵢ]_{q}_{ᵢ}·qᵢ* is in [0, q−1] so that no modular multiplication is required to compute the product.

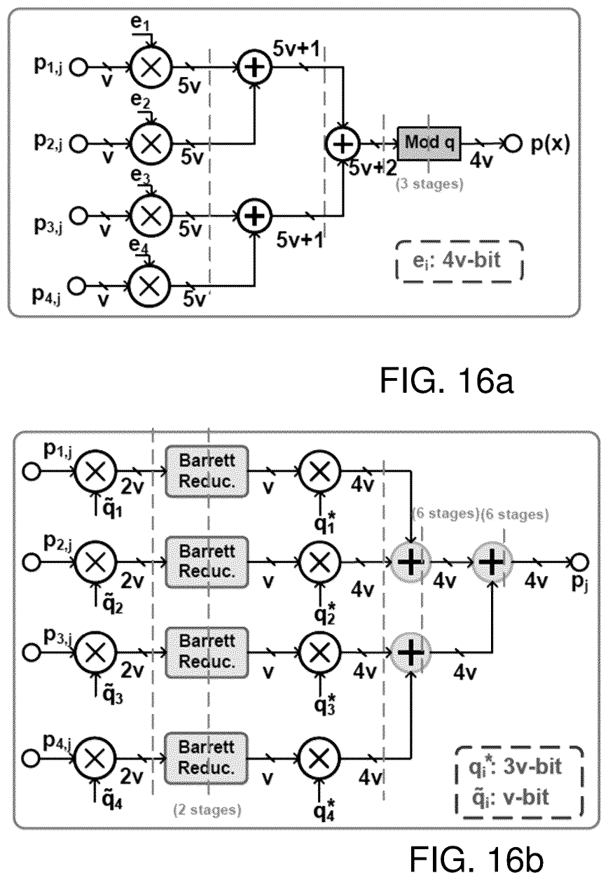

The optimized architecture of the inverse mapping of residual coefficients of polynomials is shown in FIG. 16(b) (t=4 is used as an example). In this architecture, each long word-length (4v×v-bit) multiplier for multiplying eᵢ is split into v×v-bit multiplier with constant \tilde{q}ᵢ and v×2vbit multiplier with constant qᵢ*. Instead of implementing an expensive modular reduction over a large modulus q block in FIG. 16(a), only three modular adders and four modular reductions over qᵢ are required to obtain the final result p(x). Specifically, the modular reduction over qᵢ is also efficient based on the special co-prime.

### Experimental Results

This section evaluates the co-prime factor selection and performance of the parallel NTT-based polynomial multiplier without shuffling operations and pre-processing/post-processing units for the CRT algorithm separately. Subsequently, a comprehensive performance discussion and comparison analysis of the PaReNTT polynomial multiplier is presented.

For the evaluations, the proposed designs were implemented using System Verilog and then mapped to the Xilinx Virtex Ultrascale+ FPGA. A fixed 180-bit q with either four or six co-prime factors and a polynomial degree of n=4096 was used to investigate the designs under different levels of CRT-based parallelism. Consequently, the 180-bit modulus q is composed of co-primes that are either 45-bit or 30-bit, and these co-primes adhere to special NTT-compatible and CRT-friendly formats.

Note that the embodiments can be easily extended to a longer word-length modulus by either incorporating more co-prime factors or by increasing the word length of each individual co-prime. Moreover, in the case of a length-4096 and t=4 NTT-based polynomial multiplier, 48 PEs and 44 DSD units are employed given that m=log₂(4096)=12. When t=6, 72 PEs and 66 DSD units are applied. A higher degree of the polynomial can also be integrated, requiring solely an increment in the number of PEs and DSDs.

### Expansion of Co-Prime Factors

Table III shows the total number of special NTT-compatible and CRT-friendly primes under different settings. Two values of μ are chosen: μ=(2v+15) and (2v+30). The number of signed power-of-two terms are either 4 or 5. When μ, the number of signed power-of-two terms, and n are set to be (2v+30)-bit, five terms, and length-4096, respectively, the feasible co-prime factors are 169 (for v=30) and 480 (for v=45) in number. Thus, the number of coprime factors is large enough to accommodate long word-lengths of coefficients. In one hardware implementation, 75-bit and 105-bit μ are considered for the 30-bit (v=30) and 45-bit (v=45) co-primes (corresponding to μ=(2v+15)). Moreover, each of these co-primes is characterized by four signed power-of-two terms.

TABLE III
THE NUMBER OF SPECIAL NTT-COMPATIBLE
AND CRT-FRIENDLY PRIMES UNDER DIFFERENT
SETTINGS WHEN t = 4 AND t =
6 (v = 45 AND 30)

| t | v | μ | # POT | n | [log_{2ϵ}] | # primes |
|---|---|---|---|---|---|---|
| 4 | 45 | (2v + 15) | 4 | 4096 | 61 | 12 |
| 4 | 45 | (2v + 30) | 4 | 4096 | 76 | 33 |
| 4 | 45 | (2v + 15) | 5 | 4096 | 61 | 126 |
| 4 | 45 | (2v + 30) | 5 | 4096 | 76 | 480 |
| 6 | 30 | (2v + 15) | 4 | 4096 | 46 | 8 |
| 6 | 30 | (2v + 30) | 4 | 4096 | 61 | 26 |
| 6 | 30 | (2v + 15) | 5 | 4096 | 46 | 23 |
| 6 | 30 | (2v + 30) | 5 | 4096 | 61 | 169 |

μ: The input word-length of Barrett reduction unit; # PoT: The number of signed power-of-two terms in each co-prime.

### Evaluation Metrics and Performance of Parallel NTT-Based Polynomial Multiplier

To analyze the timing performances of the implementations, we define two timing performance metrics, block processing period (BPP) and latency. BPP is defined as the time required to process n coefficient inputs or the time required to generate n coefficient outputs. For a length-n NTT-based two-parallel polynomial multiplier, the expression for BPP is

$${T}_{BPP} = n / 2 , \qquad ( 11 )$$

where the throughput is two samples per clock cycle. In addition, the latency for one modular polynomial multiplication is

$${T}_{L a t} = ( n - 2 ) + {T}_{pipe} , \qquad ( 12 )$$

where Tₚᵢₚₑ represents the additional pipelining stages added to the data-path in order to reduce the critical path. Furthermore, the total clock cycles consumed by L modular polynomial multiplications are

$${T}_{total} = {T}_{L a t} + {T}_{BPP} \cdot L . \qquad ( 13 )$$

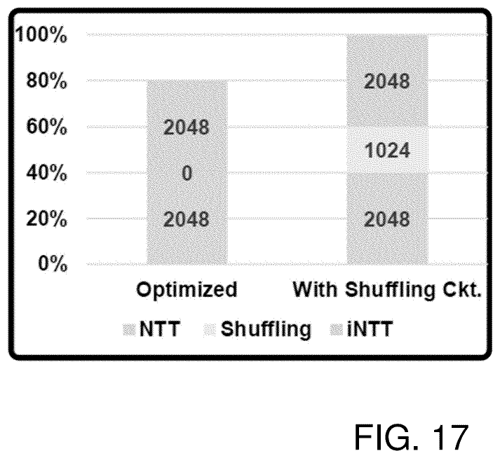

For n=4096, the BPP is 2048 clock cycles, and the latency is 4096 clock cycles (excluding extra clock cycles required for pipelining). The latency is significantly reduced compared to the NTT-based polynomial multipliers that use a shuffling circuit. The comparison of our optimized and conventional methods (without considering the pipelining) is shown in FIG. 17. Specifically, the conventional method with the shuffling circuit needs additional 1024 (n/4 in general) clock cycles for the re-ordering, leading to an increase in latency by around 20.0% for a two-parallel design and n=4096.

### Comparison of Residual Coefficient Computation Unit and Inverse Mapping Architecture

FIG. 14 and FIG. 15 illustrate and compare the designs for residual coefficient, and FIG. 16 presents inverse mapping computations architecture. The experimental results and comparison, both with and without the incorporation of pipelining for these foundational components, are presented in Tables IV and V. The pipelining cut sets in the building blocks are marked in FIG. 14, FIG. 15, and FIG. 16.

TABLE IV
AREA CONSUMPTION AND FREQUENCY FOR
RESIDUAL COEFFICIENT COMPUTATION
UNIT WHEN t = 4 AND t =
6 ([log2qi] = 45 AND 30)

| Design | t | Freq. | LUTs | DSPs | FFs | Npip |
|---|---|---|---|---|---|---|
| Prior | 4 | 76 | 6350 | 0 | 0 | 0 |
| Embodiment | 4 | 62 | 4034 | 0 | 0 | 0 |
| Prior | 4 | 200 | 5836 | 0 | 1288 | 5 |
| Embodiment | 4 | 271 | 3937 | 0 | 1164 | 6 |
| Prior | 6 | 105 | 2032 | 0 | 0 | 0 |
| Embodiment | 6 | 55 | 1148 | 0 | 0 | 0 |
| Prior | 6 | 300 | 2660 | 0 | 1244 | 6 |
| Embodiment | 6 | 309 | 1537 | 0 | 682 | 6 |

TABLE V
AREA CONSUMPTION AND FREQUENCY FOR INVERSE
MAPPING ARCHITECTURE WHEN t =
4 AND [log2qi] = 45

| Design | Freq. | LUTs | DSPs | FFs | Npip |
|---|---|---|---|---|---|
| Prior | 45 | 17729 | 63 | 0 | 0 |
| Embodiment | 50 | 15894 | 60 | 0 | 0 |
| Prior | 111 | 15066 | 63 | 2544 | 6 |
| Embodiment | 244 | 12302 | 60 | 6686 | 16 |

In evaluating the results for our proposed residual coefficient computation unit, we have considered the experimental results for two distinct approaches presented in FIG. 14 (for v=45, t=4) and FIG. 15 (for v=30, t=6). Additionally, we reference the prior design delineated in FIG. 11(a) and implemented it in a fully parallel manner with our parameter setting and Barrett reduction units. This has been employed as a baseline for the comparison of the residual coefficient computation unit presented in Table IV. Both pipelined and non-pipelined designs are considered. From non-pipelined designs (Nₚᵢₚ=0), we observe that the area requirements of the proposed designs for preprocessing are less than those of the prior design. A comparison between the prior design (FIG. 11(a)) and the proposed design of FIG. 14 reveals a shorter critical path in the former before pipelining. These designs are feed-forward and can be pipelined at appropriate levels. For a fair comparison, both designs are appropriately pipelined to facilitate high-speed operation. The result indicates a significant reduction of 32.5% in LUT consumption in our design. Such saving mainly comes from replacing the four integer multipliers and four Barrett reduction units by two Barrett reduction units augmented by additional low-cost SAU units. Meanwhile, the comparison between FIG. 11(a) and the design of the present embodiments in FIG. 15 shows a saving of LUTs increases to 67.7% after pipelining.

Besides, parameter setting of v=45 and t=4 is applied to compare conventional design FIG. 16(a) and our proposed design FIG. 16(b) for the inverse mapping architecture. The area consumption results show an 18.3% and 4.8% reduction in the usage of LUTs and DSPs in our proposed design, respectively. Such savings are primarily derived from the replacement of an expensive Barrett reduction unit with respect to q by four Barrett units using special primes qᵢ. In particular, instead of performing a multiplication with a 180-bit integer q during the Barrett reduction with q, our approach employs four short word-length shift-and-add operations to compute the multiplications with 45-bit specialized qᵢ. Although the total word-length of multipliers for \tilde{q}ᵢ and qᵢ* remains unchanged compared to the multiplier with eᵢ, the decomposition of the long word-length multiplication at the algorithmic level for our proposed hardware architecture enables a straightforward pipelining optimization without the need for further transformation.

### Evaluation on PaReNTT Polynomial Multiplier

This sub-section delves into the implementation and comparison of the proposed PaReNTT polynomial multiplier (two-parallel residue arithmetic-based NTT architecture) for n=4096 and ┌log₂ q┐=180.

The performances and experimental results for the parameter settings t=4, v=45 and t=6, v=30 are presented in Tables VI and VII. These two implementations employ the same architecture designs for the evaluation in the residual domain (i.e., the parallel NTT-based polynomial multiplier for varying qᵢ as described in Section III) and the inverse mapping of residual coefficients of the polynomial. However, the employed residual polynomial computation units for t=4 and t=6 are based on FIG. 14 and FIG. 15, respectively. Detailed breakdowns of these two blocks' results are presented in Table IV.

TABLE VI
AREA CONSUMPTION AND FREQUENCY FOR MODULAR
POLYNOMIAL MULTIPLIERS FOR n = 4096

| | | | Freq. | | | | |
|---|---|---|---|---|---|---|---|
| Design | [log₂ q] | t | [MHz] | LUTs^{a} | DSPs^{a} | FFs^{a} | Power [W] |
| Embodiment | 180 | 4 | 244 | 322K (27.2%) | 1.6K (22.8%) | 92K (3.9%) | 6.6 |
| | 180 | 6 | 240 | 341K (28.9%) | 1.1K (16.5%) | 103K (4.3%) | 6.3 |
| Prior | 180 | 6 | 225 | 64K | 0.3K | 25K | (Not Reported) |

^{a}# of used resources (% utilization) on FPGA board.

TABLE VII
TIMING PERFORMANCE FOR MODULAR POLYNOMIAL MULTIPLIERS FOR n = 4096

| | | | BPP^{b} | | Latency^{c} | | | | | |
|---|---|---|---|---|---|---|---|---|---|---|
| | | | | Period | | Period | ABP^{d} | ABP^{d} | ATP^{e} | ATP^{e} |
| [log₂ q] | t | CRT | # Cycles | [μs] | # Cycles | [μs] | (LUT) | (DSP) | (LUT) | (DSP) |
| 180 | 4 | Yes | 2048 | 8.5 | 4246 | 17.4 | 2.7M | 13.1K | 5.6M | 27.8K |
| 180 | 6 | Yes | 2048 | 8.4 | 4254 | 17.7 | 2.9M | 9.6K | 6.0M | 19.5K |
| 180 | 6 | Yes | N/A | N/A | 196003 | 871.1 | N/A | N/A | 55.8M | 261.3K |

^{b}Block processing period (BPP) is the period (μs) for processing n coefficient inputs or for generating n sample outputs after the first sample out.
^{c}Latency is the period (μs) of the first sample in and the first sample out.
^{d}ABP is calculated from the number of LUTs/DSPs times BPP (μs).
^{e}ATP is calculated from the number of LUTs/DSPs times latency (μs).

In terms of timing performance, both designs can operate at a high clock frequency of 240 MHz after pipelining. It can also be observed that the BPP and latency, measured in clock cycles, remain similar regardless of the varying word-length v due to the degree of the polynomial being fixed. Furthermore, the area performance of PaReNTT architectures for t=4 and t=6 is also examined. As illustrated in Table VI, the implementation for t=6 utilizes an additional 5.6% of LUTs, while concurrently reducing DSP usage by 31.25% compared to the design implemented for t=4.

To comprehensively compare the timing and area performances of the embodiments, we evaluate the area-BPP product (ABP). The reductions in ABP(LUT) and ABP(DSP) achieved by the t=6 design are 6.90% and 26.72%, respectively, when compared to the t=4 design.

The main sources of power consumption in our PaReNTT architectures are the shift registers deployed in the DSD units, in addition to the logic operations executed in LUTs and DSPs. Since the t=6 implementation utilizes fewer resources, it is associated with a reduction in power consumption. Specifically, it is approximately 4.5% lower when compared to the t=4 implementation.

Although the parameter setting of n=4096 and ┌log₂ q┐=180 indicates superior ABP(LUT) and ABP(DSP) performance for the t=6 implementation, varying parameter selections for n, v, and t may also impact both the flexibility of co-prime factor selection and ABP performance. This suggests that the choice between designs shown in FIG. 14 or FIG. 15 and the selection of parameters should be meticulously tailored to suit the requirements of different HE applications.

Direct comparisons with prior works are difficult as systems are implemented using different data-paths and FPGA devices corresponding to different technologies. Nevertheless, we now compare an embodiment with a prior design based on the same parameter setting n=4096, log₂(q)=180 and the same FPGA device. The timing and area performances of the prior design are included in the last line of Tables VII and VI. Moreover, to reduce the variation of the parameter setting, parameter setting of v=30 and t=6 is considered in both the embodiment and the prior design.

Despite the fact that the area performance of the previous design is superior to the PaReNTT architecture, our design has a better timing performance, as reducing the latency and increasing throughput is the primary goal of this work. Specifically, the prior design incorporates a customized optimization for the BFV scheme requiring lifting and scaling operations. Consequently, the clock cycles for modular multiplication in the homomorphic multiplication are approximately doubled compared to the design without these operations. In order to provide a fair comparison, we halved the clock cycle and latency consumption for the CRT-based, NTT, and iNTT operations in their design. The equivalent number of clock cycles equals 196,003=(87,582×2+102,043+15,662+99,137)/2, and the latency is 871.1 μs.

The comparison and evaluation result shows the present embodiments reduce the latency by a factor of 49.2. Additionally, comparing the area-timing product (ATP) of these two designs, the present embodiments reduce ATP(LUT) and ATP(DSP) by 89.2% and 92.5%, respectively, compared to the prior design.

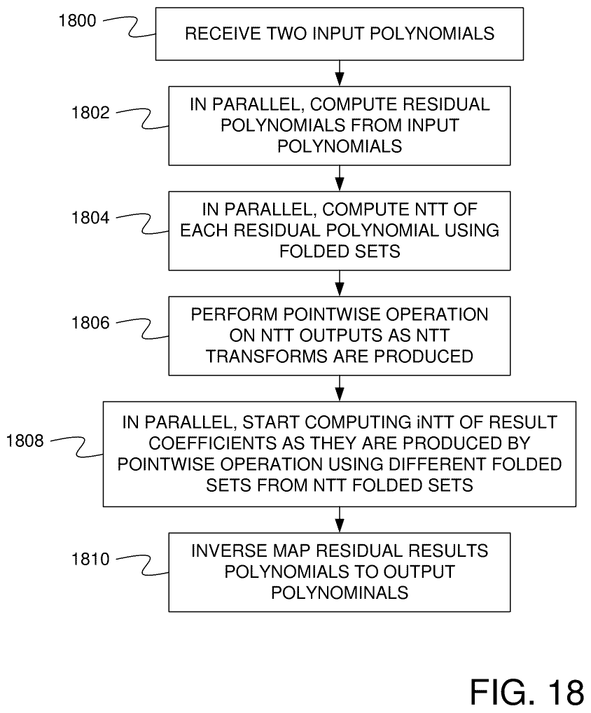

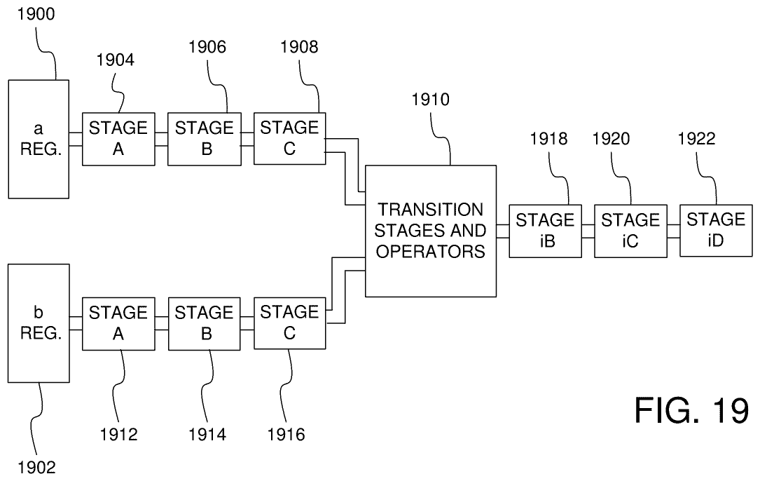

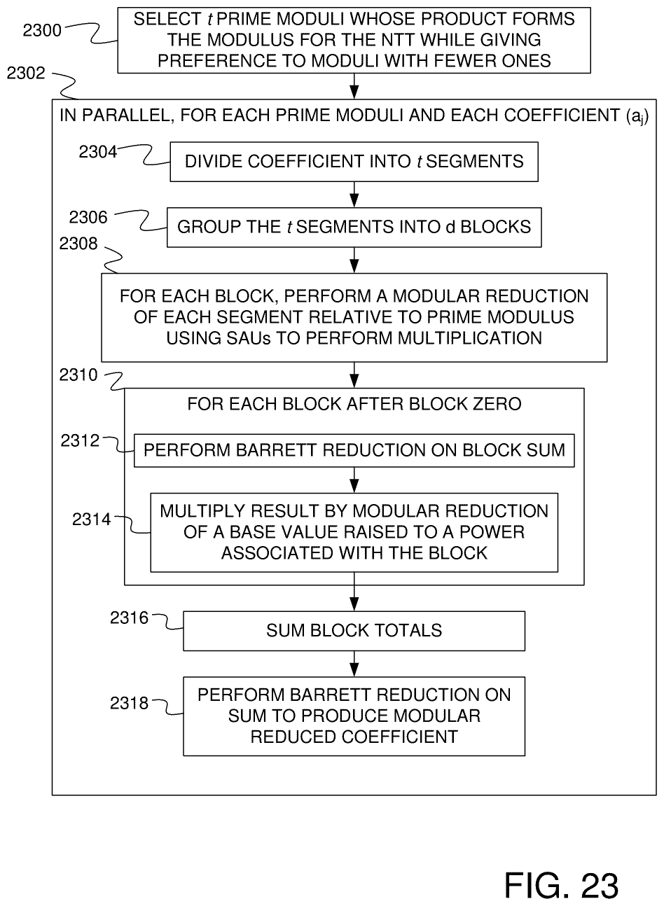

FIG. 18 provides a flow diagram of a method and FIG. 19 provides a block diagram of elements used in the method of FIG. 18 in accordance with one embodiment. In step 1800, two input polynomials are received. In step 1802, a respective set of residual polynomials are determined from each of the two input polynomials. A method for computing the residual polynomials is described below in connection with FIG. 23. In accordance with one embodiment, the residual polynomials are determined in parallel with each other to increase processing speed.

In step 1804, a number-theoretic transform (NTT) of each residual polynomial is determined using folding sets. In FIG. 19, a residual polynomial for one of the input polynomials is stored in a register 1900 and a residual polynomial for the other of the input polynomials is stored in register 1902. The NTT of the residual polynomial in register 1900 is computed using stages 1904, 1906 and 1908, and a final stage that is found within transition stages and operators 1910. The NTT of the residual polynomial in register 1902 is computed using stages 1912, 1914 and 1916, and a final stage that is found within transition stages and operators 1910. Stages 1904 and 1912 correspond to stage A in FIG. 3, stages 1906 and 1914 correspond to stage B in FIG. 3, and stages 1908 and 1916 correspond to stage C in FIG. 3.

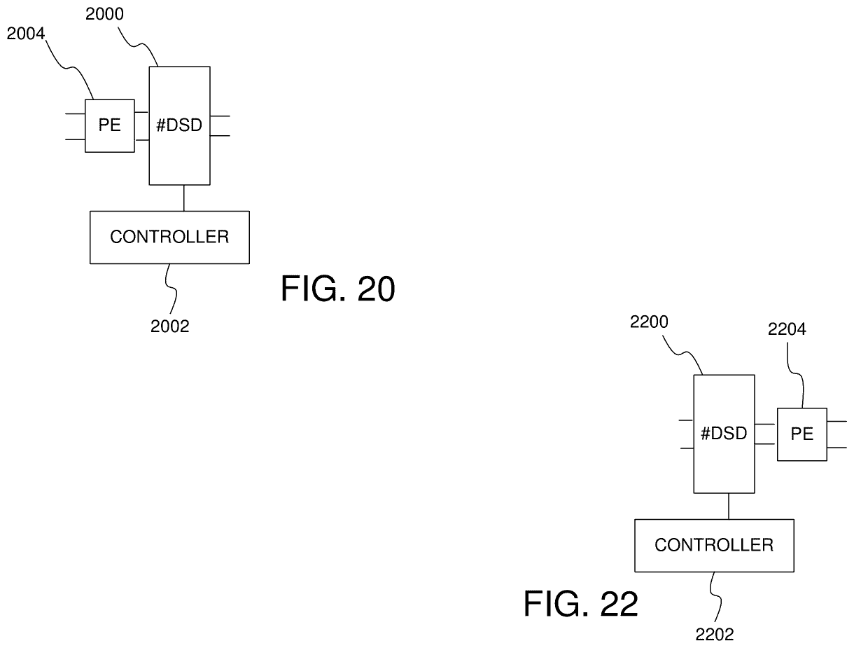

Each of stages 1904, 1906, 1908, 1912, 1914 and 1916 has a similar circuit structure as shown in the block diagram of FIG. 20. Specifically, each stage begins with a processing element 2004 that receives two inputs as directed by one of the folding sets A, B and C described above for the number-theoretic transform. Processing element 2004 performs the butterfly calculation associated with the stage to produce two output values. Because the butterfly calculations are different for different stages, processing element 2004 is different for different stages. The two output values are provided to a delay-switch-delay circuit 2000, which is controlled by a controller 2002 to implement the folding set for the next stage. Because each stage has its own folding set, delay-switch-delay 2000 is different for each stage. The clock cycles during which the various values are applied to each stage's processing element are shown in FIG. 3.

In accordance with one embodiment, controller 2002 is shared between the stages for the first polynomial and the stages for the second polynomial. For example, stages 1904 and 1912 may share a single controller 2002 such that a single control signal from controller 2002 controls delay-switch-delay circuit 2000 in both stage 1904 and stage 1912. Similar sharing arrangements may be found for the controllers of stages 1906 and 1914, and the controllers of stages 1908 and 1916.

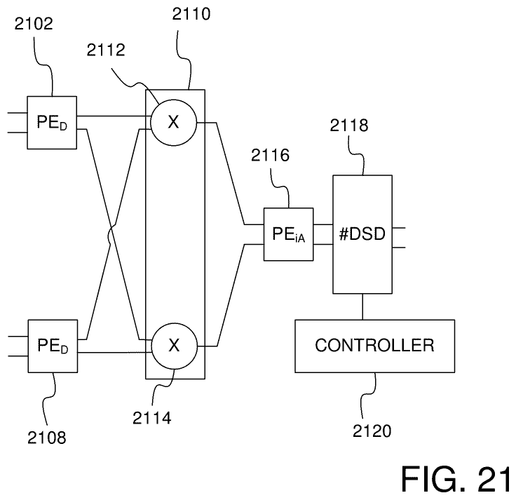

The final stage of the NTT for both input polynomials is in transition-stages-and-operators 1910, which is shown in the block diagram of FIG. 21. Specifically, processing element 2102 forms the final NTT stage for the polynomial in register 1900 and processing element 2108 forms the final NTT stage for the polynomial in register 1902. This final stage corresponds to stage D in FIG. 3.

The outputs of processing element 2102 represent the number-theoretic transform of the polynomial in register 1900 and the outputs of processing element 2108 represent the number-theoretic transform of the polynomial in register 1902. The order of the NTT coefficients output by processing elements 2102 and 2108 follows the order described in FIG. 3. For example, during the seventh clock cycle, A₀ and A₈ are output by processing element 2102 and B₀ and B₈ are output by processing element 2108.

During the next clock cycle after the values are output by processing elements 2102 and 2108, the pointwise operation between the output values starts in operator stage 2110 at step 1806 of FIG. 18. For example, if the operator is addition, an addition operation between A₀ and B₀ and an addition operation between A₈ and B₈ begin with the next clock cycle after A₀ and A₈ appear at the output of processing element 2102 and B₀ and B₈ appear at the output of processing element 2108. Similarly, when the pointwise operation is multiplication, as shown in FIG. 21, the multiplication operation 2112 between A₀ and B₀ and the multiplication operation 2114 between A₈ and B₈ begin with the next clock cycle after A₀ and A₈ appear at the output of processing element 2102 and B₀ and B₈ appear at the output of processing element 2108. As a result, the NTT values do not have to be stored or shuffled before the operation is performed.

The results of the pointwise operations are provided directly to the processing element 2116 of the first stage of the inverse number-theoretic transform. As a result, the results do not need to be stored or shuffled before being applied to the inverse number-theoretic transform at step 1808 of FIG. 18. This is made possible by the use of different folding sets for the inverse number-theoretic transform than for the number-theoretic transform. Processing element 2116 performs the butterfly operation of stage iA of the inverse number-theoretic transform of FIG. 4.

The outputs of processing element 2116 are provided to stage B of the inverse number-theoretic transform (denoted as Stage iB 1918 in FIG. 19.) Stages iB 1918, iC 1920 and iD 1922 represent the last three stages of the inverse number-theoretic transform. Each of stages iB 1918, iC 1920 and iD 1922 have the same structure as shown in FIG. 22 with a respective a delay-switch-delay circuit 2200, a respective controller 2202 and a respective processing element 2204. The outputs of the preceding stage's processing element are provided to delay-switch-delay circuit 2200, which is controlled by controller 2202 to implement the folding set for the stage. Because each stage has its own folding set, delay-switch-delay 2200 is different for each stage. The clock cycles during which the various values are applied to each stage's processing element are shown in FIG. 4. The respective processing element 2204 implements the butterfly calculation assigned to the stage of the inverse number-theoretic transform. Because the butterfly calculations are different for different stages, processing element 2204 is different for different stages.

The output of stage iD 1922 is the residual polynomial of the results of the operation performed on the number-theoretic transform values. To arrive at the final result polynomial, the values output by stage iD 1922 are mapped to output polynomials at step 1810 of FIG. 18.

FIG. 23 provides a flow diagram of a method of computing a residual polynomial from an input polynomial as found in step 1802 of FIG. 18.

In step 2300, t prime moduli are selected whose product forms the modulus for the number-theoretic transform, wherein the plurality of prime moduli are selected by giving preference to prime moduli having fewer ones in a binary representation of the prime moduli. By giving preference to such moduli, multiplication steps performed in forming the residual polynomial can be performed efficiently with shift-add units.

In step 2302, a parallel computation is started for each combination of polynomial coefficient and prime moduli, where the computation comprises steps 2304-2318 discussed below.

In step 2304, the coefficient is divided into t segments. As noted above, each segment contains v bits, which is the word length of the prime modulus. At step 2306, the t segments are grouped into d blocks. Within each block, a modular reduction of the segments of the block relative to the prime modulus is performed at step 2308. Performing the modular reduction of at least one segment comprises implementing a multiplication of a value by a modular reduction of a base value relative to the prime modulus using a shift-add-unit having a smaller area requirement than a modular multiplier. The base value is B=2^{v} such that the modular reduction is βᵢ=2^{v} mod qᵢ. The segment reductions are summed together to form a block sum as shown in FIG. 15. The top block of FIG. 15 is referred to as block 0.

At step 2310, a process consisting of steps 2312 and 2314 is begun for each block other than block 0. In step 2312, a Barrett reduction is performed on the block sum to reduce the number of bits. At step 2314, the reduced value is multiplied by a modular reduction of a base value raised to a power associated with the block designated as [βᵢ^{pt/d}]_{q}_{ᵢ}, where p is a value assigned to the block, to produce a block total.

At step 2316, all of the block totals are summed and at step 2318, a Barrett reduction is performed on the sum to produce the residual coefficient.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method of reducing chip area required to perform a number-theoretic transform of a polynomial using parallel processing, the method comprising:
receiving the modulus for the number-theoretic transform;
selecting a plurality of prime moduli whose product forms the modulus for the number-theoretic transform, wherein the plurality of prime moduli are selected by giving preference to prime moduli having fewer ones in a binary representation of the prime moduli;
for each prime modulus in the plurality of prime moduli:
selecting a coefficient of the polynomial;
dividing the coefficient into segments;
performing modular reduction of the segments relative to the prime modulus, wherein performing the modular reduction of at least one segment comprises implementing a multiplication of a value by a modular reduction of a base value relative to the prime modulus using a shift-add-unit having a smaller area requirement than a modular multiplier; and
producing a modular reduction of the coefficient relative to the prime modulus based on the modular reductions of the segments.

2. The method of claim 1 wherein performing the modular reduction of at least one segment comprises implementing a multiplication of a value by a square of a modular reduction of a base value relative to the selected prime modulus using two shift-add-units in series, each shift-add-unit having a smaller area requirement than a modular multiplier.

3. The method of claim 1 further comprising:
grouping the segments into a plurality of blocks;
for each block, using a same circuit design to form a respective sum for the respective segments of the block, the circuit design comprising a plurality of shift-add-units.

4. The method of claim 3 further comprising:
for at least one block, performing a modular reduction of the sum relative to the selected prime modulus and then multiplying the modular reduction of the sum by the modular reduction of the base value raised to a respective power designated for the block.

5. The method of claim 1 further comprising:
performing the steps of selecting a coefficient, dividing the coefficient into segments performing modular reduction of the segments and producing a modular reduction coefficient for each coefficient in the polynomial to produce a modular reduction of the polynomial.

6. The method of claim 5 further comprising performing a number-theoretic transform of the modular reduction of the polynomial to produce a transformed polynomial, performing a mathematical operation on the transformed polynomial to produce a result polynomial and performing an inverse number-theoretic transform of the result polynomial.

7. The method of claim 6 wherein performing the number-theoretic transform of the modular reduction of the polynomial comprises using a first folding set and wherein performing the inverse number-theoretic transform of the modular reduction comprises using a second folding set, wherein the second folding set is different from the first folding set.

8. A specialized circuit for performing a number-theoretic transform, the specialized circuit comprising:
a decomposition circuit for decomposing a coefficient of a polynomial into a plurality of values for a plurality of segments of the coefficient;
a plurality of identical circuit blocks;
parallel sets of conductors connecting the decomposition circuit to the plurality of identical circuit blocks, each set of conductors carrying a respective value of the plurality of segments, wherein multiple respective sets of conductors are connected to each identical circuit block; and
wherein each identical circuit block comprises at least one shift-add-unit.

9. The specialized circuit of claim 8 wherein each identical circuit block provides a sum at an output of the identical circuit block, each sum representing a sum of modular reductions of the segments provided to the identical circuit block.

10. The specialized circuit of claim 9 further comprising additional elements to produce modular reduction of the coefficient from the outputs of the identical blocks.

11. The specialized circuit of claim 10 further comprising a decomposition circuit, a plurality of identical circuit blocks, parallel sets of conductors, and additional elements for each coefficient of the polynomial such that a modular reduction of each coefficient of polynomial is produced.

12. The specialized circuit of claim 11 further comprising a number-theoretic transform circuit that receives the modular reductions of each coefficient and that comprises a plurality of stages, each stage comprising a processing element and a delay-switch-delay circuit, wherein the delay-switch-delay circuits are controlled to implement folding sets for transforming the modular reductions of each coefficient into number-theoretic transform coefficients.

13. The specialized circuit of claim 12 further comprising an operation circuit that performs a pointwise operation with the number-theoretic transform coefficients.

14. The specialized circuit of claim 13 further comprising an inverse number-theoretic transform circuit that receives the results of the pointwise operation and that comprises a plurality of stages, each stage comprising a processing element and a delay-switch-delay circuit, wherein the delay-switch-delay circuit of the inverse number-theoretic transform circuit are controlled to implement a different folding set from the folding set of the number-theoretic transform.

15. A circuit comprising:
a partial number-theoretic transform circuit comprising a plurality of stages, each stage comprising a respective processing element and a respective delay-switch-delay circuit, wherein together, the respective delay-switch-delay circuits are controlled to implement a first folding set;
a transition and operator circuit coupled to the partial number-theoretic transform circuit and providing:
a final stage of the number-theoretic transform circuit,
a pointwise operation on outputs of the number-theoretic transform circuit and,
a first stage of an inverse number-theoretic transform circuit; and
a partial inverse number-theoretic transform circuit receiving values from the first stage of the inverse number-theoretic transform circuit and comprising a plurality of stages, each stage comprising a respective processing element and a respective delay-switch-delay circuit, wherein together, the respective delay-switch-delay circuits of the inverse number-theoretic transform circuit are controlled to implement a second folding set different from the first folding set.

16. The circuit of claim 15 wherein the partial number-theoretic transform circuit comprises a first plurality of stages for a first set of coefficients and a second plurality of stages for a second set of coefficients, wherein the delay-switch-delay circuits for the first plurality of stages and the second plurality of stages implement the first folding set.

17. The circuit of claim 16 wherein the transition circuit comprises a final stage for the first set of coefficients comprising a first instance of a final stage processing element and the transition circuit comprises a final stage for the second set of coefficients comprising a second instance of the final stage processing element and wherein an output of the first instance of the final stage processing element and an output of the second instance of the final stage processing element are provided to a pointwise operator to perform the pointwise operation.

18. The circuit of claim 17 wherein the first stage of the inverse number-theoretic transform circuit comprises a processing element and an output of the pointwise operator is connected to an input of the processing element.

19. The circuit of claim 18 wherein the pointwise operator begins performing the pointwise operation on values at the output of the first instance and second instance of the final stage processing element during a next clock cycle after the values appear at the outputs of the first instance and second instance of the final stage processing element.

20. The circuit of claim 18 wherein the processing element of the first stage of the inverse number-theoretic transform begins processing a value at the output of the pointwise operator at a next clock cycle after the value appears at the output of the pointwise operator.
